(19) United States
(12) Patent Application Publication
(10) Pub. No.: US 2004/0044881 A1
(43) Pub. Date: Mar. 4, 2004

(54) Method and system for early speculative store-load bypass

(75) Inventors: Robert M. Maier, San Jose, CA (US); Sorin Iacobovici, San Jose, CA (US); Rabin Sugumar, Sunnyvale, CA (US); Robert Nuckolls, Santa Clara, CA (US); Ali Vahidsafa, Palo Alto, CA (US); Chandra M. R. Thimmannagari, Fremont, CA (US)

Correspondence Address: ZAGORIN O'BRIEN & GRAHAM, L.L.P., 7600B N. CAPITAL OF TEXAS HWY., SUITE 350, AUSTIN, TX, 78731, US

(73) Assignee: Sun Microsystems, Inc.

(21) Appl. No.: 10/229,495

(22) Filed: Aug. 28, 2002

(51) Int. Cl. G06F 9/30

(52) U.S. Cl. 712/218; 712/225

(57) ABSTRACT

In an embodiment, the present invention describes a method and apparatus for detecting RAW condition earlier in an instruction pipeline. The store instructions are stored in a special store bypass buffer (SBB) within an instruction decode unit (IDU). The IDU compares the instruction fields that are used for address generation of all ‘load’ instructions against ‘store’ instructions within a group of fetched instructions and ‘store’ instructions previously stored in the SBB. If a match of instruction fields is found, the IDU ‘speculates’ that the load instruction has dependency on the ‘store’ instruction. A data cache unit (DCU) validates the dependency of the load instruction ‘speculated’ by the IDU. If a false dependency is ‘speculated’ by the IDU, the DCU forces a re-fetch of the load instruction.

### FIELD OF THE INVENTION

Present invention relates to out of order processor architecture, specifically to read-after-write (RAW) bypass in the out of order processor.

### DESCRIPTION OF THE RELATED ART

Generally, in out of order processors, when an instruction attempts to read a location that has been modified, it creates a condition called read-after-write (RAW). In most out of order processors, RAW condition is detected at the Store Queue boundary. Typically, the address (physical or virtual) of a store instruction is compared against the address (physical or virtual) of a load instruction. If a match is found, the data from store instruction is forwarded to the load instruction.

Typically, the RAW condition is detected before accessing the main memory for data in a cache (e.g., data cache unit or the like). The cache unit includes load and store queues. The load/store addresses are compared in the cache before accessing the main memory. Detecting the RAW condition late in the instruction pipeline (e.g., in the cache, before accessing the main memory or the like) degrades the performance of out of order processors. Further, it requires additional multiplexers to forward data from the store queue to the load instruction which complicates store queue design. Adding additional devices (e.g., multiplexers, comparator logic with each entry of store queue or the like) results in additional power dissipation in the out of order processors. A method and an apparatus are needed to detect the RAW condition earlier in the instruction pipeline.

### SUMMARY

In one embodiment, a method and apparatus for detecting RAW condition earlier in an instruction pipeline is described. The store instructions are stored in a special store bypass buffer (SBB) within an instruction decode unit (IDU). The IDU compares the instruction fields that are used for address generation (e.g., immediate fields, register fields or the like) of all ‘load’ instructions against ‘store’ instructions within a group of fetched instructions and ‘store’ instructions previously stored in the SBB. If a match of instruction fields is found between the ‘load’ and the ‘store’ instruction, the IDU ‘speculates’ that the load instruction has dependency on the ‘store’ instruction. The IDU transfers the instruction fields' pointers from the ‘store’ instruction to the ‘load’ instruction and the ‘load’ instruction is then scheduled for execution with newly assigned instruction fields. A data cache unit (DCU) validates the dependency of the load instruction ‘speculated’ by the IDU by comparing the actual address of the load instruction and the store instruction. If a false dependency is ‘speculated’ by the IDU, the DCU forces a re-fetch of the load instruction.

In some embodiment, a method for determining dependency of a load instruction is described. The method includes identifying one or more instruction fields of the load instruction, comparing the one or more instruction fields of the load instruction with one or more instruction field of one or more store instructions and determining whether the one or more instruction fields of the load instruction match with the one or more instruction fields of the one or more store instructions. According to some variations of the present invention, the comparing is done using one or more instruction field identifications of the one or more instruction fields. In some variation the comparing is done using contents of the one or more instruction fields.

In some variation, the method includes declaring the dependency of the load instruction on one of the one or more store instructions if the one or more instruction fields of the load instruction match with the one or more instruction fields of one of the one or more store instructions. In some variation, the method includes declaring the dependency of the load instruction on a most recently fetched store instruction from one of the one or more store instruction whose one or more instruction fields matched with one or more instruction fields of the load instruction if the one or more instruction fields of the load instruction match with the one or more instruction fields of more than one of the one or more store instructions. According to an embodiment of the present invention, one of the instruction fields is an immediate field. According to some variations, one of the instruction fields is a register field. In some variation, the identifying, comparing and determining is done during instruction decoding.

The method includes fetching a group of instructions. In some variation, the load instruction is one of the group of instructions. According to other variation the present invention, the one or more store instructions are from the group of instructions. According to an embodiment of the present invention, the one or more store instructions are stored in a store bypass buffer.

The method includes performing a data bypass between the load instruction and one of the one or more store instructions whose one or more instruction fields matched with one or more instruction fields of the load instruction. According to some embodiment of the present invention, performing the data bypass further comprises assigning the one or more instruction field identifications of the one or more instruction fields of the one of the one or more store instructions to the load instruction. The method includes storing the one or more store instructions in the store bypass buffer if the group of instructions includes the one or more store instructions. The method includes forwarding the load instruction for execution.

The method includes validating the dependency of the load instruction upon one of the one or more store instructions. In some variations, the validating comprises comparing the physical addresses of one or more instruction fields of the load instruction with physical address of the one or more instruction fields of the one or more store instructions. The method includes, if the contents of the one or more instruction fields of the load instruction do not match with the one or more instruction fields of one or more store instructions, requesting a re-fetch of the load instruction.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 illustrates an example of processor architecture according to an embodiment of the present invention.

FIG. 2 is a flow diagram illustrating an exemplary sequence of operations performed during a process detecting instruction dependency according to an embodiment of the present invention.

FIG. 3 is a flow diagram illustrating an exemplary sequence of operations performed when a ‘dependent’ load instruction is received according to an embodiment of the present invention.

The use of the same reference symbols in different drawings indicates similar or identical items.

### DESCRIPTION OF THE PREFERRED EMBODIMENT(S)

The following is intended to provide a detailed description of an example of the invention and should not be taken to be limiting of the invention itself. Rather, any number of variations may fall within the scope of the invention which is defined in the claims following the description.

In addition, the following detailed description has been divided into sections in order to highlight the invention described herein; however, those skilled in the art will appreciate that such sections are merely for illustrative focus, and that the invention herein disclosed typically draws its support from multiple sections. Consequently, it is to be understood that the division of the detailed description into separate sections is merely done as an aid to understanding and is in no way intended to be limiting.

Introduction

In some embodiment, the present invention describes a method and apparatus for detecting RAW condition earlier in an instruction pipeline. The store instructions are stored in a special store bypass buffer (SBB) within an instruction decode unit (IDU). The IDU compares the instruction fields that are used for address generation (e.g., immediate fields, register fields or the like) of all ‘load’ instructions against ‘store’ instructions within a group of fetched instructions and ‘store’ instructions previously stored in the SBB. If a match of instruction fields is found between the ‘load’ and the ‘store’ instruction, the IDU ‘speculates’ that the load instruction has dependency on the ‘store’ instruction. The IDU transfers the instruction fields' pointers from the ‘store’ instruction to the ‘load’ instruction and the ‘load’ instruction is then scheduled for execution with newly assigned instruction fields. A data cache unit (DCU) validates the dependency of the load instruction ‘speculated’ by the IDU by comparing the actual address of the load instruction and the store instruction. If a false dependency is ‘speculated’ by the IDU, the DCU forces a re-fetch of the load instruction.

### DETAILED ARCHITECTURAL DESCRIPTION

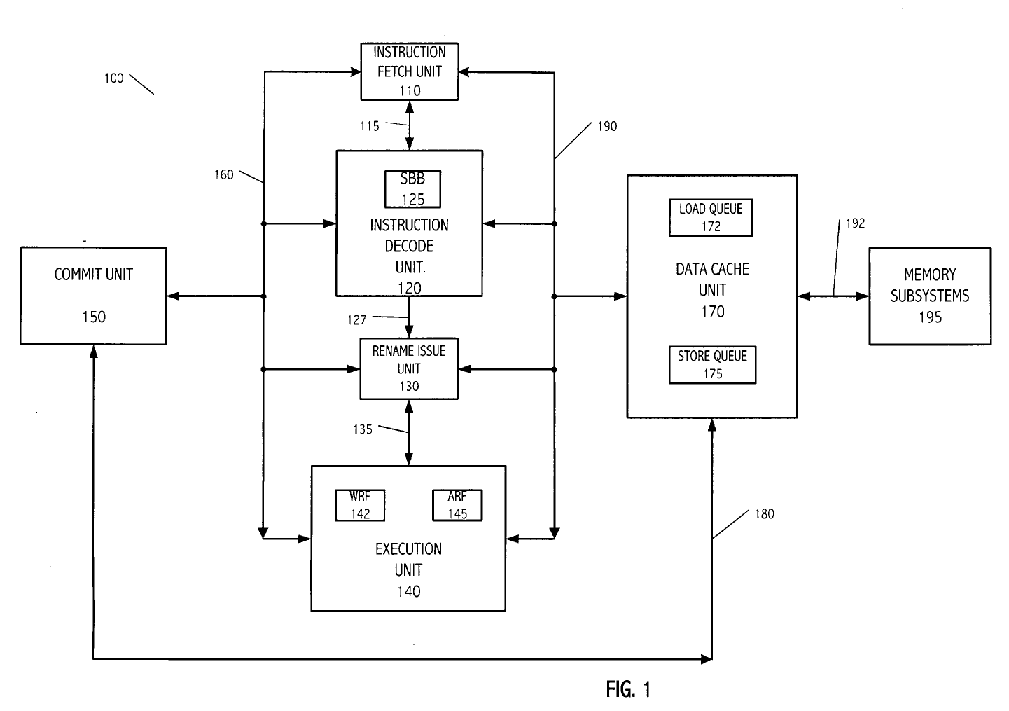

FIG. 1 illustrates an example of a core 100 for an out of order processor according to an embodiment of the present invention. A system may include one or more cores such as core 100. Core 100 includes an Instruction Fetch Unit (IFU) 110. IFU 110 is coupled via a link 115 to an Instruction Decode Unit (ID U) 120. IFU 110 fetches a group of instructions to be executed (e.g., in one cycle or the like) and forwards the group of instructions to IDU 120. IDU 120 decodes the group of instructions fetched by IFU 110. IDU 120 includes a Store Bypass Buffer (SBB) 125. SBB125 can be configured as any storage element (e.g., first-in-first-out, first-in-last-out or the like). The size of SBB 125 can be of any length (e.g., same as the number of instructions fetched in a group or the like). In the present example, SBB 125 is configured as first-in-first-out storage element

IDU 120 identifies ‘store’ instructions from the group of instructions fetched by IFU 110 and stores them into SBB 125. IDU assigns a temporary scratch register for each one of the ‘store’ and ‘load’ instructions. According to an embodiment of the present invention, IDU assigns a temporary scratch register ‘rd’ to each ‘store’ instruction, extends the instruction fields of each load instruction using a temporary register and assigns a temporary register ‘rs’ to each one of ‘load’ instruction. The ‘rs’ field is used to identify the source register for data bypass using ‘rd’ field of the store instruction once a dependency between a ‘store’ and a ‘load’ instruction is declared valid. The use of temporary register fields is one of several means that can be used to bypass data between dependent instructions. Other means such as, indirect addressing, transfer of data pointers between instructions or the like can be used to bypass data between dependent instructions.

IDU 120 identifies ‘load’ instructions from the group of fetched instructions and compares the instruction fields of the ‘load’ instructions with the instruction fields of ‘store’ instructions within the group of fetched instructions and with ‘store’ instructions stored in SBB 125. When a match of instruction fields between a load instruction and a ‘store’ instruction is found, IDU 120 ‘speculates’ that the ‘load’ instruction is dependent upon the ‘store’ instruction and declares the dependency of the ‘load’ instruction upon the ‘store’ instruction by forwarding the ‘rd’ field of the matching ‘store’ on to the newly assigned ‘rs’ field of the ‘load.’ IDU 120 then forwards the group of fetched instructions via a link 127 to a Rename Issue Unit (RIU) 130. RIU 130 renames the instruction fields (e.g., the source registers of the instructions or the like), checks the dependencies of instructions and when instructions are ready to be issued, issues the instructions via a link 135 to an Execution Unit (EXU) 140. IDU 120 renames the destination registers of ‘store’ and ‘load’ instructions.

EXU 140 includes a Working Register File (WRF) 142 and an Architectural Register File (ARF) 145. WRF 142 and ARF 145 can be any storage elements. In the present example, ARF 145 includes temporary scratch registers (e.g., register ‘rd’ or the like). EXU140 executes instructions and stores the results into WRF 142. EXU 140 is coupled to a Commit Unit (CMU) 150 via a common link 160. Link 160 couples various elements of core 100 as shown in FIG. 1. CMU 150 monitors instructions and determines whether the instructions are ready to be committed. When an instruction is ready to be committed, CMU 150 writes the associated results from WRF 142 into ARF 145. The functions of RIU 130, WRF 142, ARF 145 and CMU 150 are known in art. CMU 150 is coupled to a Data Cache Unit (DCU) 170 via a link 180. DCU 170 is further coupled to various elements of core 100 via a link 190 as shown in FIG. 1. DCU 170 further includes a Load Queue (LDQ) 172 and a Store Queue (STQ) 175. LDQ 172 is responsible for managing load and store requests and STQ 175 is responsible for managing store requests. DCU 170 is coupled via a link 192 to a memory sub-system 195. The functions of DCU 170 are known in art. Conventionally, DCU 170 performs load/store bypass after comparing the physical addresses of load and store destinations.

Determining Instruction Dependency

Initially, in the first fetch cycle, IFU 110 fetches a group of instructions. For purposes of illustration, in the present example, IFU 110 fetches a group of three instructions. However, IFU 150 can fetch any number of instructions supported by the architecture of core 100. IDU 120 decodes the group of fetched instructions and determines whether there are any ‘load’ and ‘store’ instructions in the group of fetched instructions. If there are ‘load’ and ‘store’ instructions in the group of fetched instructions, IDU 120 compares the instruction fields of the ‘load’ instruction (e.g., fields used in address generation such as register field, immediate field or the like) with the instruction fields of the ‘store’ instruction in the fetch group and writes the ‘store’ instructions into SBB 125. If a match is found between the instruction fields of the ‘load’ and a ‘store’ instruction, IDU 120 ‘speculates’ that the ‘load’ instruction is dependent upon the ‘store’ instruction and identifies the ‘load’ instruction as dependent upon the ‘store’ instruction. The dependency of ‘load’ instructions can be identified using various techniques known in art. If there are no ‘load’ instructions but ‘store’ instructions in the fetch group, IDU 120 stores those ‘store’ instructions in SBB 125. If there are ‘load’ instructions but no ‘store’ instructions in the fetch group then IDU does not force any dependency as SSB 125 in this case is empty. In the present example, the size of SBB 125 is same as the size of the group of fetched instructions (e.g., three or the like). However, SBB 125 can be of any size supported by core 100 architecture.

IDU 120 then determines whether there are any ‘load’ instructions in the group of fetched instructions. If there are ‘load’ instructions in the group of fetched instructions, IDU 120 compares the instruction fields of the ‘load’ instructions (e.g., register field, immediate field or the like) with the instruction fields of the ‘store’ instructions in SBB 125. If a match is found between the instruction fields of the ‘load’ and a ‘store’ instruction, EDU 120 ‘speculates’ that the ‘load’ instruction is dependent upon the ‘store’ instruction and identifies the ‘load’ instruction as dependent upon the ‘store’ instruction. The dependency of ‘load’ instructions can be identified using various techniques known in art.

Typically, IDU 120 does not analyze the instruction fields of ‘load’ and ‘store’ instructions (e.g., actual contents of the instruction fields, physical addresses of the instruction fields or the like). Because the contents of the instruction fields are not analyzed, the dependency of the ‘load’ instruction is a ‘speculation’ by IDU 120. ‘Speculating’ a dependency in IDU 120 and performing a data bypass in RIU 130 and EXU 140 allows a younger dependent instruction to be issued sooner than the conventional execution in the out of order processors. Conventionally, the younger dependent instructions are not issued until the comparison of addresses and data bypass is done in DCU 170.

In the following fetch cycle, before storing ‘store’ instructions in SBB 125, IDU 120 first identifies and compares the instruction fields of ‘load’ instructions with ‘store’ instructions in the group of fetched instructions and then with the instruction fields of ‘store’ instructions stored in SBB 125. Thus, in every following fetch cycle, load instructions are compared against ‘store’ instructions of incoming fetch group and previous fetch group in SBB 125.

Once IDU 120 identifies a ‘load’ instruction as dependent upon a ‘store’ instruction, IDU 120 forwards the assigned ‘rd’ field of the ‘store’ instruction on to the newly assigned instruction field ‘rs’ of the ‘load’ instruction and the load instruction is executed using the newly assigned instruction fields. The data between the ‘load’ instruction and the ‘store’ instruction is by-passed in RIU 130 and EXU 140 using ‘rd’ and ‘rs’ register fields. Upon receiving the ‘dependent’ ‘load’ instruction, DCU 170 determines whether the dependency of the ‘load’ instruction was validly ‘speculated’ by IDU 120. The determination of dependency validity can be made using various techniques known in art (e.g., by comparing the physical addresses or the like). If the dependency of the ‘load’ instruction was validly ‘speculated’ by IDU 120, DCU 170 maintains the dependency of the ‘load’ instruction. If DCU 170 determines that dependency of the ‘load’ instruction was not validly ‘speculated’ by IDU 120 then DCU 170 forces a re-fetch of the ‘load’ instruction.

When IDU 120 identifies a ‘load’ instruction having its instruction fields (e.g., register, immediate, or the like) common with more than one ‘store’ instructions (i.e. multiple dependencies), IDU 120 forces the ‘load’ instruction to be dependant on the most recently fetched (‘youngest’) ‘store’ instruction prior to this ‘load’. When a ‘load’ instruction is dependent upon a ‘store’ instruction that is not part of the group of instructions fetched by IFU 110 or stored in SBB 125 then the dependency is identified by DCU 170 using conventional means.

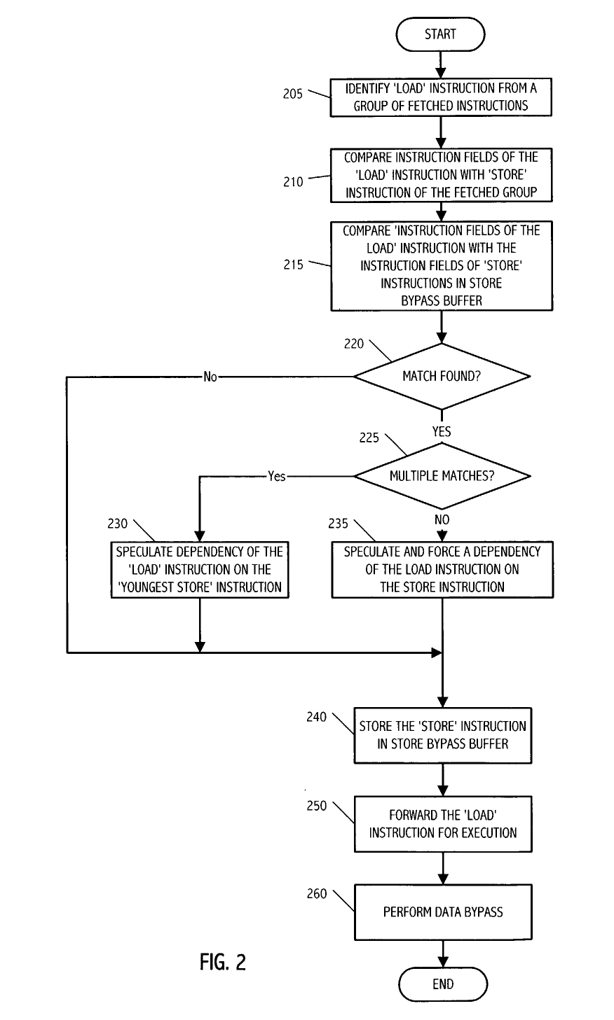

FIG. 2 is a flow diagram illustrating an exemplary sequence of operations performed during a process of detecting instruction dependency in an instruction decoding unit (e.g., IDU 120) according to an embodiment of the present invention. While the operations are described in a particular order, the operations described herein can be performed in other sequential orders (or in parallel) as long as dependencies between operations allow. In general, a particular sequence of operations is a matter of design choice and a variety of sequences can be appreciated by persons of skill in art based on the description herein.

Initially, the process identifies ‘load’ instructions from a group of instructions fetched by an instruction fetch unit (e.g., IFU 110 or the like) (205). The process then first compares the instruction fields of ‘load’ instructions (e.g., immediate field, register field or the like) with one or more ‘store’ instructions within the group of fetched instructions, if any (210). The process then compares the instruction fields of ‘load’ instructions with the instruction fields of ‘store’ instructions stored in a ‘store’ instruction buffer (e.g., SBB 125) (215).

The process then determines whether there was a match between the instruction fields of ‘load’ instructions and one or more ‘store’ instructions (220). If there was no match between the instruction fields of ‘load’ instructions and ‘store’ instructions, the process proceeds to store the ‘store’ instructions in the store bypass buffer (240). If there was match between the instruction fields of ‘load’ instructions and ‘store’ instructions, the process determines whether the instruction fields of the ‘load’ instructions matched with the instruction fields of more than one ‘store’ instructions within the group of fetched instructions and ‘store’ instructions stored in the store bypass buffer (225). If the instruction fields of the ‘load’ instructions matched with instruction fields of more than one ‘store’ instructions within the group of fetched instructions and ‘store’ instructions stored in the store bypass buffer, the process forces the ‘load’ instruction to be dependant on the ‘youngest’ ‘store’ instruction prior to this ‘load’ (230). The process then proceeds to store the ‘store’ instructions in the store bypass buffer (240).

If the instruction fields of the ‘load’ instruction did not match with instruction fields of more than one ‘store’ instructions from the group of fetched instructions and ‘store’ instructions stored in the store bypass buffer, the process ‘speculates’ that the ‘load’ instruction is dependent upon the ‘store’ instruction and ‘forces’ a dependency of the ‘load’ instruction upon the ‘store’ instruction that matched the instruction fields of the ‘load’ instruction (235). According to one embodiment, after forcing the dependency, the process forwards the ‘rd’ field of the ‘store’ instruction to the newly assigned ‘rs’ field of the ‘load’ instruction.

The process stores the ‘store’ instructions, if any, from the group of fetched instructions, into the store bypass buffer (step240). The process then forwards the instruction for execution (e.g., forwarding the instruction to RIU 130 or the like) (250). The process executes the ‘load’ instruction using the newly assigned instruction fields. The process then performs the data bypass for the ‘load’ instruction (260). The data bypass can be performed using various techniques known in art.

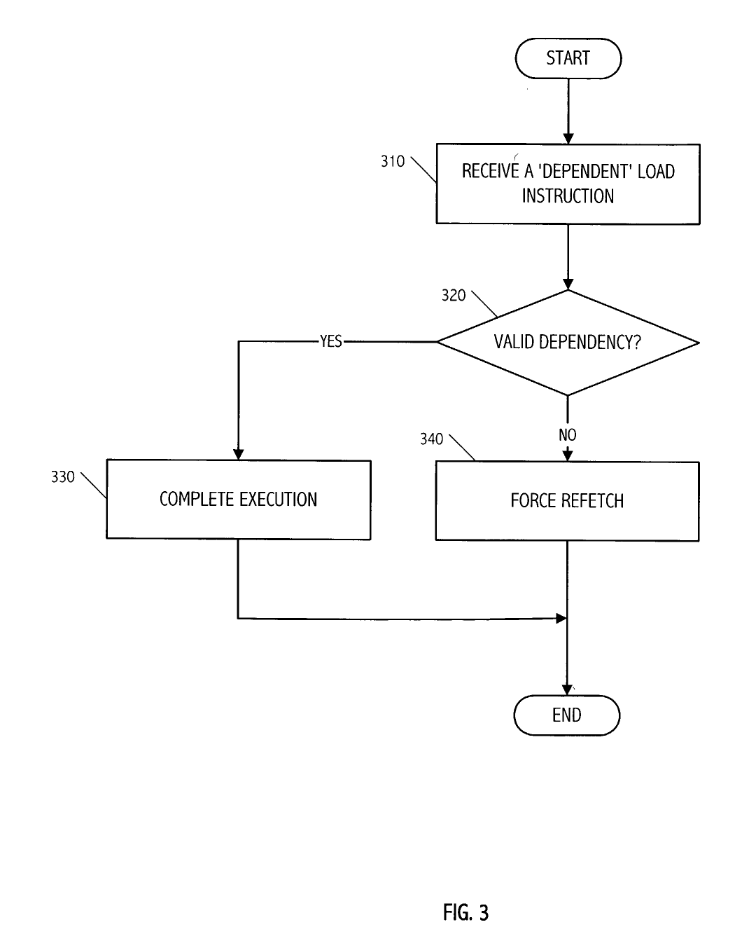

FIG. 3 is a flow diagram illustrating an exemplary sequence of operations performed when a ‘dependent load’ instruction is received according to an embodiment of the present invention. The steps described herein can be performed in any order (e.g., sequentially, parallel or the like). Initially, the process receives a ‘dependent’ load instruction (e.g., at DCU 170 or the like) (310). The dependency of the load instruction can be determined using the process such as the one described in FIG. 2. The process then determines whether the dependency of the ‘load’ instruction is valid (320). The validity of the dependencies can be determined using various techniques known in art. According to an embodiment of the present invention, the process determines the validity of the dependency by comparing the contents of instruction fields of the ‘load’ instructions and the ‘store’ instruction (e.g., actual comparison of immediate instruction fields, physical addresses or the like).

If dependency of the ‘load’ instruction is valid, the process completes the execution of instructions (330). If the dependency of the ‘load’ instruction is not valid, the process forces a re-fetch of the instruction (340). When the process forces a re-fetch, the ‘load’ instruction is fetched again (e.g., by IFU 110 or the like) and is processed again according to the instruction execution process.

The above description is intended to describe at least one embodiment of the invention. The above description is not intended to define the scope of the invention. Rather, the scope of the invention is defined in the claims below. Thus, other embodiments of the invention include other variations, modifications, additions, and/or improvements to the above description. For example, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

The above described method, the operations thereof and modules therefor may be executed on a computer system configured to execute the operations of the method and/or may be executed from computer-readable media. Computer systems may be found in many forms including but not limited to mainframes, minicomputers, servers, workstations, personal computers, notepads, personal digital assistants, various wireless devices and embedded systems, just to name a few. A typical computer system includes at least one processing unit, associated memory and a number of input/output (I/O) devices. A computer system processes information according to a program and produces resultant output information via I/O devices. A program is a list of instructions such as a particular application program and/or an operating system. A computer program is typically stored internally on computer readable storage media or transmitted to the computer system via a computer readable transmission medium. A computer process typically includes an executing (running) program or portion of a program, current program values and state information, and the resources used by the operating system to manage the execution of the process. A parent computer process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

The method described above may be embodied in a computer-readable medium for configuring a computer system to execute the method. The computer readable media may be permanently, removably or remotely coupled to system 100 or another system. The computer readable media may include, for example and without limitation, any number of the following: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc.; and data transmission media including permanent and intermittent computer networks, point-to-point telecommunication equipment, carrier wave transmission media, the Internet, just to name a few. Other new and various types of computer-readable media may be used to store and/or transmit the software modules discussed herein.

It is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

Because the above detailed description is exemplary, when “one embodiment” is described, it is an exemplary embodiment. Accordingly, the use of the word “one” in this context is not intended to indicate that one and only one embodiment may have a described feature. Rather, many other embodiments may, and often do, have the described feature of the exemplary “one embodiment.” Thus, as used above, when the invention is described in the context of one embodiment, that one embodiment is one of many possible embodiments of the invention.

While particular embodiments of the present invention have been shown and described, it will be obvious to those skilled in the art that, based upon the teachings herein, various modifications, alternative constructions, and equivalents may be used without departing from the invention claimed herein. Consequently, the appended claims encompass within their scope all such changes, modifications, etc. as are within the spirit and scope of the invention. Furthermore, it is to be understood that the invention is solely defined by the appended claims. The above description is not intended to present an exhaustive list of embodiments of the invention. Unless expressly stated otherwise, each example presented herein is a non-limiting or nonexclusive example, whether or not the terms non-limiting, nonexclusive or similar terms are contemporaneously expressed with each example. Although an attempt has been made to outline some exemplary embodiments and exemplary variations thereto, other embodiments and/or variations are within the scope of the invention as defined in the claims below.

What is claimed is:

1. A method of preparing instructions for execution comprising:
determining whether one or more instruction fields of a load instruction match with one or more instruction fields of one or more store instructions wherein said determining is performed during instruction decoding.

2. The method of claim 1, wherein one of said instruction fields is an immediate field.

3. The method of claim 1, wherein one of said instruction fields is a register field.

4. The method of claim 1, further comprising:
fetching a group of instructions.

5. The method of claim 4, wherein said load instruction is one of said group of instructions.

6. The method of claim 4, wherein said one or more store instructions are from said group of instructions.

7. The method of claim 4, further comprising:
storing one or more of said one or more store instructions in a store bypass buffer if said group of instructions includes said one or more store instructions.

8. The method of claim 1, wherein said determining further comprises:
comparing said one or more instruction fields of said load instruction with one or more instruction fields of said one or more store instructions.

9. The method of claim 8, wherein said comparing is performed using one or more instruction field identifications of said one or more instruction fields of said load instruction and said one or more store instructions.

10. The method of claim 8, wherein said comparing is performed using contents of said one or more instruction fields of said load instruction and said one or more store instructions.

11. The method of claim 8, further comprising:
if said one or more instruction fields of said load instruction match with said one or more instruction fields of one of said one or more store instructions,
declaring dependency of said load instruction on said one of said one or more store instructions.

12. The method of claim 8, further comprising:
declaring dependency of said load instruction on a most recently fetched store instruction from one of said one or more store instruction whose one or more instruction fields matched with one or more instruction fields of said load instruction if said one or more instruction fields of said load instruction match with said one or more instruction fields of more than one of said one or more store instructions.

13. The method of claim 8, further comprising:
performing a data bypass between said load instruction and said one of said one or more store instructions whose one or more instruction fields matched with one or more instruction fields of said load instruction.

14. The method of claim 13, wherein said performing said data bypass further comprises:
assigning said one or more instruction field identifications of said one or more instruction fields of said one of said one or more store instructions to said load instruction.

15. The method of claim 13, further comprising:
validating dependency of said load instruction on said one of said one or more store instructions.

16. The method of claim 15, wherein said validating further comprises:
comparing physical address of said one or more instruction fields of said load instruction with physical address of said one or more instruction fields of said one or more store instructions.

17. The method of claim 16, further comprising:
requesting a re-fetch of said load instruction if said physical address of said one or more instruction fields of said load instruction do not match with physical address of said one or more instruction fields of one or more store instructions.

18. The method of claim 15, further comprising:
forwarding said load instruction for execution.

19. A system for preparing instructions for execution comprising:
a store bypass buffer configured to store one or more store instructions;
an instruction decode unit comprising said store bypass buffer.

20. The system of claim 19, wherein said instruction decode unit is configured to
compare one or more instruction fields of said load instruction with one or more instruction fields of one or more store instructions; and
determine whether said one or more instruction fields of said load instruction match with said one or more instruction fields of said one or more store instructions.

21. The system of claim 19, wherein said instruction decode unit is further configured to declare dependency of said load instruction on said one of said one or more store instructions if said one or more instruction fields of said load instruction match with said one or more instruction fields of one of said one or more store instructions.

22. The system of claim 19, wherein said instruction decode unit is further configured to declaring said dependency of said load instruction on a most recently fetched store instruction from one of said one or more store instruction whose one or more instruction fields matched with one or more instruction fields of said load instruction if said one or more instruction fields of said load instruction match with said one or more instruction fields of more than one of said one or more store instructions

23. The system of claim 19, wherein said instruction decode unit is further configured to assign said one or more instruction field identifications of said one or more instruction fields of said one of said one or more store instructions to said load instruction.

24. The system of claim 19, further comprising:
an instruction fetch unit, coupled to said instruction decode unit and configured to fetch a group of instructions.

25. The system of claim 24, wherein said instruction decode unit is further configured to store said one or more store instructions in said store bypass buffer if said group of instructions includes said one or more store instructions.

26. The system of claim 19, further comprising:
a data cache unit, coupled to said instruction decode unit and configured to validate dependency of a load instruction on said one of said one or more store instructions.

27. The system of claim 26, wherein said data cache unit comprises:
a load queue configured to store said load instruction; and
a store queue configured to store said one or more store instructions.

28. The system of claim 27, wherein said data cache unit is further configured to compare physical addresses of said one or more instruction fields of said load instruction and said one or more instruction fields of said one or more store instructions.

29. The system of claim 28, wherein said data cache unit is further configured to request a re-fetch of said load instruction if physical addresses of said one or more instruction fields of said load instruction and said one or more instruction fields of one or more store instructions do not match.

30. The system of claim 19, further comprising:
an instruction rename unit coupled to said instruction decode unit and configured to perform data bypass between said load instruction and said one of said one or more store instructions; and
an execution unit coupled to said instruction decode unit and configured to execute said instructions.

31. The system of claim 30, wherein said execution unit further comprises:
a working register file comprising a first plurality of memory storage elements; and
an architectural register file comprising a second plurality of memory storage elements.

32. A system for preparing instructions for execution comprising:
means for determining whether one or more instruction fields of a load instruction match with one or more instruction fields of one or more store instructions wherein said determining is performed during instruction decoding.

33. The system of claim 32, further comprising:
means for fetching a group of instructions.

34. The system of claim 32, further comprising:
means for comparing said one or more instruction fields of said load instruction with one or more instruction fields of said one or more store instructions.

35. The system of claim 32, further comprising:
means for declaring dependency of said load instruction on said one of said one or more store instructions if said one or more instruction fields of said load instruction match with said one or more instruction fields of one of said one or more store instructions.

36. The system of claim 32, further comprising:
means for declaring dependency of said load instruction on a most recently fetched store instruction from one of said one or more store instruction whose one or more instruction fields matched with one or more instruction fields of said load instruction if said one or more instruction fields of said load instruction match with said one or more instruction fields of more than one of said one or more store instructions.

37. The system of claim 32, further comprising:
means for performing a data bypass between said load instruction and said one of said one or more store instructions whose one or more instruction fields matched with one or more instruction fields of said load instruction.

38. The system of claim 32, further comprising:
means for validating dependency of said load instruction on said one of said one or more store instructions;
means for comparing physical address of said one or more instruction fields of said load instruction with physical address of said one or more instruction fields of said one or more store instructions;
means for requesting a re-fetch of said load instruction if said physical address of said one or more instruction fields of said load instruction do not match with said one or more instruction fields of one or more store instructions; and
means for forwarding said load instruction for execution.

39. A computer program product for preparing instructions for execution comprising a set of instructions encoded in a computer readable media, said set of instructions is configured to determine whether one or more instruction fields of a load instruction match with one or more instruction fields of one or more store instructions wherein said determining is performed during instruction decoding.

40. The computer program product of claim 39, wherein said set of instructions is further configured to fetch a group of instructions.

41. The computer program product of claim 39, wherein said set of instructions is further configured to store one or more of said one or more store instructions in a store bypass buffer if said group of instructions includes said one or more store instructions.

42. The computer program product of claim 39, wherein said set of instructions is further configured to
compare said one or more instruction fields of said load instruction with one or more instruction fields of said one or more store instructions;
declare dependency of said load instruction on said one of said one or more store instructions if said one or more instruction fields of said load instruction match with said one or more instruction fields of one of said one or more store instructions; and
declare dependency of said load instruction on a most recently fetched store instruction from one of said one or more store instruction whose one or more instruction fields matched with one or more instruction fields of said load instruction if said one or more instruction fields of said load instruction match with said one or more instruction fields of more than one of said one or more store instructions.

43. The computer program product of claim 39, wherein said set of instructions is further configured to perform a data bypass between said load instruction and said one of said one or more store instructions whose one or more instruction fields matched with one or more instruction fields of said load instruction.

44. The computer program product of claim 39, wherein said set of instructions is further configured to validate dependency of said load instruction on said one of said one or more store instructions.

45. The computer program product of claim 39, wherein said set of instructions is further configured to request a re-fetch of said load instruction if said physical address of said one or more instruction fields of said load instruction do not match with physical address of said one or more instruction fields of one or more store instructions.
